(19) United States
(12) Patent Application Publication
(10) Pub. No.: US 2011/0228696 A1
(43) Pub. Date: Sep. 22, 2011

(54) DYNAMIC DIRECTED ACYCLIC GRAPH (DAG) TOPOLOGY REPORTING

(76) Inventors: Navneet Agarwal, Bangalore (IN); Jean-Philippe Vasseur, Saint Martin dUriage (FR); Vivek N. Achar, Bangalore (IN)

(21) Appl. No.: 12/790,028

(22) Filed: May 28, 2010

(30) Foreign Application Priority Data
Mar. 19, 2010 (IN) 642/DEL/2010

(51) Int. Cl. H04L 12/28; H04L 12/26

(52) U.S. Cl. 370/253; 370/255

(57) ABSTRACT

In one embodiment, a root device of a directed acyclic graph (DAG) may determine/detect a trigger to learn a network topology of the DAG. In response, the root device may transmit a DAG discovery request down the DAG with a route record request that requests that each device within the DAG add its device identification (ID) to a reverse route record stack for each route of a DAG discovery reply propagated up the DAG toward the root device. Upon receiving one or more DAG discovery replies, the root device may compile the recorded routes from the reverse route record stacks into a DAG network topology. Also, in one embodiment, the root device may determine “short-cuts” based on a traffic matrix generated in response to network statistics optionally included within the responses from the devices within the DAG.

### RELATED APPLICATION

The present invention claims priority to commonly owned Indian Patent Application Serial No. 642/DEL/2010, entitled DYNAMIC DIRECTED ACYCLIC GRAPH (DAG) TOPOLOGY REPORTING, by Agarwal, et al., on Mar. 19, 2010, the contents of which are incorporated by reference.

### TECHNICAL FIELD

The present disclosure relates generally to computer networks, and, more particularly, to directed acyclic graph (DAG) routing, e.g., for Low power and Lossy Networks (LLNs).

### BACKGROUND

Low power and Lossy Networks (LLNs), e.g., sensor networks, have a myriad of applications, such as Smart Grid and Smart Cities. Various challenges are presented with LLNs, such as lossy links, low bandwidth, battery operation, low memory and/or processing capability, etc. One example routing solution to LLN challenges is a protocol called Routing Protocol for LLNs or “RPL,” which is a distance vector routing protocol that builds a Destination Oriented Directed Acyclic Graph (DODAG) in addition to a set of features to bound the control traffic, support local (and slow) repair, etc. The RPL architecture provides a flexible method by which each node performs DODAG discovery, construction, and maintenance.

As in many DAG architectures, such as RPL and other suitable distance vector routing protocols, each node in a network constructs DODAG edges and maintains them, thus managing information about its peers and their roles. However, in such situations (by contrast with link state routing protocols), no node has information on the complete network topology. In addition, a system administrator has no way of knowing what is the DODAG structure, how it is changing over time, and whether the DODAG has been built and maintained correctly.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network and directed acyclic graphs (DAGs)/tree;

FIG. 2 illustrates an example network device/node;

FIG. 3 illustrates an example message;

FIG. 4 illustrates an example reverse route record stack field;

FIG. 5 illustrates an example computer network with “short-cuts”; and

FIG. 6 illustrates an example procedure for providing dynamic DAG topology recording.

### DESCRIPTION OF EXAMPLE EMBODIMENTS

### Overview

According to one or more embodiments of the disclosure, a root device of a directed acyclic graph (DAG) in a computer network may determine/detect a trigger to learn a network topology of the DAG. In response, the root device may transmit a DAG discovery request down the DAG, the DAG discovery request having a route record request that requests that each device within the DAG add its device identification (ID) to a reverse route record stack for each route of a DAG discovery reply propagated up the DAG toward the root device. Upon receiving one or more DAG discovery replies, the root device may compile the recorded routes from the reverse route record stacks into a DAG network topology. Also, according to one or more embodiments of the disclosure, particular devices may receive the DAG discovery request, and in response to the route record request, may add their device ID to the reverse route record stack for each route of a DAG discovery reply for transmission to the root device. Further, in one or more embodiments, the root device may determine “short-cuts” based on a traffic matrix generated in response to network statistics optionally included within the responses from the devices within the DAG.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area is networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC). In addition, a Mobile Ad-Hoc Network (MANET) is a kind of wireless ad-hoc network, which is generally considered a self-configuring network of mobile routes (and associated hosts) connected by wireless links, the union of which forms an arbitrary topology.

Smart object networks, such as sensor networks, in particular, are a specific type of network consisting of spatially distributed autonomous devices such as sensors that cooperatively monitor physical or environmental conditions at different locations, such as, e.g., temperature, pressure, vibration, sound, radiation, motion, pollutants, etc. Other types of smart object in LLNs are actuators, e.g., responsible for turning on/off an engine or perform any other actions. Sensor networks are typically wireless networks, though wired connections are also available. That is, in addition to one or more sensors, each sensor device (node) in a sensor network may generally be equipped with a radio transceiver or other communication port, a microcontroller, and an energy source, such as a battery. Generally, size and cost constraints on sensor nodes result in corresponding constraints on resources such as energy, memory, computational speed and bandwidth. Correspondingly, a reactive routing protocol may, though need not, be used in place of a proactive routing protocol for sensor networks.

In certain configurations, the sensors in a sensor network transmit their data to one or more centralized or distributed database management nodes that obtain the data for use with one or more associated applications. Alternatively (or in addition), certain sensor networks provide for mechanisms by which an interested subscriber (e.g., “sink”) may specifically request data from devices in the network. In a “push mode,” the sensors transmit their data to the sensor sink/subscriber without prompting, e.g., at a regular interval/frequency or in response to external triggers. Conversely, in a “pull mode,” the sensor sink may specifically request that the sensors (e.g., specific sensors or all sensors) transmit their current data (or take a measurement, and transmit that result) to the sensor sink. (Those skilled in the art will appreciate the benefits and shortcomings of each mode, and both apply to the techniques described herein.)

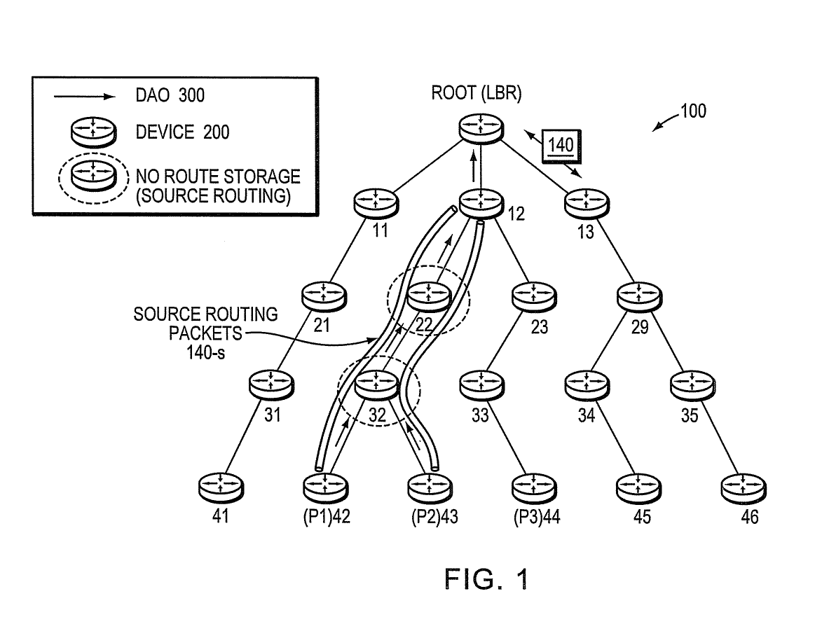

FIG. 1 is a schematic block diagram of an example computer network 100 illustratively comprising nodes/devices 200, such as, e.g., routers, sensors, computers, etc., interconnected by various methods of communication (e.g., and labeled as shown, “LBR,” “11,” “12,” . . . “46”). For instance, the links may be wired links or may comprise a wireless communication medium, where certain nodes 200 may be in communication with other nodes 200, e.g., based on distance, signal strength, current operational status, location, etc. Those skilled in the art will understand that any number of nodes, devices, links, etc. may be used in the computer network, and that the view shown herein is for simplicity. Illustratively, certain devices in the network may be more capable than others, such as those devices having larger memories, sustainable non-battery power supplies, etc., versus those devices having minimal memory, battery power, etc. For instance, as noted below, certain devices 200 may have no or limited memory capability, as denoted by the dashed circles. As described further herein, one or more of the devices 200 may be considered “root nodes/devices,” while one or more of the devices may also be considered “destination nodes/devices.”

Data packets 140 (e.g., traffic and/or messages sent between the devices/nodes) may be exchanged among the nodes/devices of the computer network 100 using predefined network communication protocols such as the Transmission Control Protocol/Internet Protocol (TCP/IP), User Datagram Protocol (UDP), Multi-Protocol Label Switching (MPLS), various proprietary protocols, etc. In this context, a protocol consists of a set of rules defining how the nodes interact with each other. In addition, packets within the network 100 may be transmitted in a different manner depending upon device capabilities, such as source routed packets 140-s, as described below.

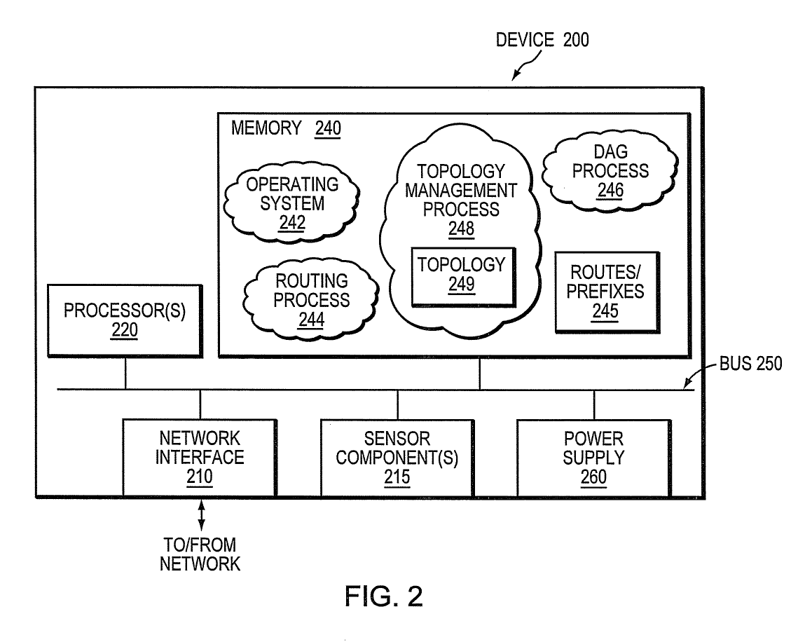

FIG. 2 is a schematic block diagram of an example node/device 200 that may be used with one or more embodiments described herein, e.g., as a device or sensor. The is device may comprise one or more network interfaces 210, one or more sensor components 215, a processor 220 (e.g., an 8-64 bit microcontroller), and a memory 240 interconnected by a system bus 250, as well as a power supply 260 (e.g., battery, plug-in, etc.). The network interface(s) 210 contain the mechanical, electrical, and signaling circuitry for communicating data over physical and/or wireless links coupled to the network 100. The network interfaces may be configured to transmit and/or receive data using a variety of different communication protocols, including, inter alia, TCP/IP, UDP, wireless protocols (e.g., IEEE Std. 802.15.4, WiFi, Bluetooth®,), Ethernet, powerline communication (PLC) protocols, etc.

The memory 240 comprises a plurality of storage locations that are addressable by the processor(s) 220 and the network interfaces 210 for storing software programs and data structures associated with the embodiments described herein. As noted above, certain devices may have limited memory or no memory (e.g., no memory for storage other than for programs/processes operating on the device). The processors 220 may comprise necessary elements or logic adapted to execute the software programs and manipulate the data structures, such as routes or prefixes 245 (notably on capable devices only). An operating system 242, portions of which are typically resident in memory 240 and executed by the processor(s), functionally organizes the device by, inter alia, invoking operations in support of software processes and/or services executing on the device. These software processes and/or services may comprise routing process/services 244, which may include an illustrative directed acyclic graph (DAG) process 246. Also, for root devices (or other management devices), a topology management process 248 and associated stored topologies 249 may also be present in memory 240, for use as described herein. It will be apparent to those skilled in the art that other processor and memory types, including various computer-readable media, may be used to store and execute program instructions pertaining to the techniques described herein.

Routing process (services) 244 contains computer executable instructions executed by the processor 220 to perform functions provided by one or more routing protocols, such as proactive or reactive routing protocols as will be understood by those is skilled in the art. These functions may, on capable devices, be configured to manage a routing/forwarding table 245 containing, e.g., data used to make routing/forwarding decisions. In particular, in proactive routing, connectivity is discovered and known prior to computing routes to any destination in the network, e.g., link state routing such as Open Shortest Path First (OSPF), or Intermediate-System-to-Intermediate-System (ISIS), or Optimized Link State Routing (OLSR). Reactive routing, on the other hand, discovers neighbors (i.e., does not have an a priori knowledge of network topology), and in response to a needed route to a destination, sends a route request into the network to determine which neighboring node may be used to reach the desired destination. Example reactive routing protocols may comprise Ad-hoc On-demand Distance Vector (AODV), Dynamic Source Routing (DSR), DYnamic MANET On-demand Routing (DYMO), etc. Notably, on devices not capable or configured to store routing entries, routing process 244 may consist solely of providing mechanisms necessary for source routing techniques. That is, for source routing, other devices in the network can tell the less capable devices exactly where to send the packets 140-s, and the less capable devices simply forward the packets as directed.

Low power and Lossy Networks (LLNs), e.g., certain sensor networks, may be used in a myriad of applications such as for “Smart Grid” and “Smart Cities.” A number of challenges in LLNs have been presented, such as:

1) Links are generally lossy, such that a Packet Delivery Rate/Ratio (PDR) can dramatically vary due to various sources of interferences, e.g., considerably affecting the bit error rate (BER);

2) Links are generally low bandwidth, such that control plane traffic must generally be bounded and negligible compared to the low rate data traffic;

3) There are a number of use cases that require specifying a set of link and node metrics, some of them being dynamic, thus requiring specific smoothing functions to avoid routing instability, considerably draining bandwidth and energy;

4) Constraint-routing may be required by some applications, e.g., to establish routing paths that will avoid non-encrypted links, nodes running low on energy, etc.;

5) Scale of the networks may become very large, e.g., on the order of several is thousands to millions of nodes; and

6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example protocol specified in an Internet Engineering Task Force (IETF) Internet Draft, entitled “RPL: IPv6 Routing Protocol for Low Power and Lossy Networks”<draft-ietf-roll-rp1-07> by Winter, at al. (Mar. 8, 2010 version), provides a mechanism that supports multipoint-to-point (MP2P) traffic from devices inside the LLN towards a central control point (e.g., LLN Border Routers (LBRs) or “root nodes/devices” generally), as well as point-to-multipoint (P2MP) traffic from the central control point to the devices inside the LLN (and also point-to-point, or “P2P” traffic). RPL (pronounced “ripple”) may generally be described as a distance vector routing protocol that builds a Directed Acyclic Graph (DAG) for use in routing traffic/packets 140, in addition to defining a set of features to bound the control traffic, support repair, etc.

A DAG is a directed graph having the property that all edges are oriented in such a way that no cycles (loops) exist. All edges are contained in paths oriented toward and terminating at one or more root nodes (e.g., “clusterheads or “sinks”), often to interconnect the devices of the DAG with a larger infrastructure, such as the Internet, a wide area network, or other domain. In addition, a Destination Oriented DAG (DODAG) is a DAG rooted at a single destination, i.e., at a single DAG root with no outgoing edges. A “parent” of a particular node within a DAG is an immediate successor of the particular node on a path towards the DAG root, such that the parent has a lower “rank” than the particular node itself, where the rank of a node identifies the node's position with respect to a DAG root (e.g., the farther away a node is from a root, the higher is the rank of that node). Further, a sibling of a node within a DAG is defined as any neighboring node which is located at the same rank within a DAG. Note that siblings do not necessarily share a common parent, and routes between siblings are generally not part of a DAG since there is no forward progress (their rank is the same). Note also that a tree is a kind of DAG, where each device/node in the DAG has one parent or, as used herein, one preferred parent.

DAGs may generally be built based on an Objective Function (OF), which defines a set of routing metrics, optimization objectives, constraints, and related functions are in use in a DAG. That is, role of the Objective Function is to specify one or more metrics to optimize the DAG against, as well as how these are used to compute a best (e.g., shortest) path. Also, the OF may include an optional set of constraints to compute a constrained path, such as where if a link or a node does not satisfy a required constraint, it is “pruned” from the candidate list when computing the best path. Additionally, OFs may include a “goal” that defines a host or set of hosts, such as a host serving as a data collection point, or a gateway providing connectivity to an external infrastructure, where a DAG's primary objective is to have the devices within the DAG be able to reach the goal. In the case where a node is unable to comply with an objective function, it may be configured to join a DAG as a leaf node.

Illustratively, example metrics used to select paths (e.g., preferred parents) may comprise cost, delay, latency, bandwidth, estimated transmission count (ETX), etc., while example constraints that may be placed on the route selection may comprise various reliability thresholds, restrictions on battery operation, multipath diversity, load balancing requirements, bandwidth requirements, transmission types (e.g., wired, wireless, etc.), and also a number of selected parents (e.g., single parent trees or multi-parent DAGs). Notably, an example for how routing metrics may be obtained may be found in an IETF Internet Draft, entitled “Routing Metrics used for Path Calculation in Low Power and Lossy Networks”<draft-ietf-roll-routing-metrics-04> by Vasseur, et al. (Dec. 3, 2009 version). Further, an example OF (e.g., a default OF) may be found in an IETF Internet Draft, entitled “RPL Objective Function 0”<draft-ietf-roll-of 0-01> by Thubert (Feb. 18, 2010 version).

Building a DAG may utilize a discovery mechanism to build a logical representation of the network, and route dissemination to establish state within the network so that routers know how to forward packets toward their ultimate destination. Note that a “router” refers to a device that can forward as well as generate traffic, while a “host” refers to a device that can generate but does not forward traffic. Also, a “leaf” may be used to generally describe a non-router that is connected to a DAG by one or more routers, but cannot itself forward traffic received on the DAG to another router on the DAG. Control messages may be transmitted among the devices within the network for discovery and route dissemination when building a DAG.

According to the illustrative RPL protocol, a DODAG Information Object (DIO) is a type of DAG discovery request message that carries information that allows a node to discover a RPL Instance, learn its configuration parameters, select a DODAG parent set, and maintain the upward routing topology. In addition, a Destination Advertisement Object (DAO) is a type of DAG discovery reply message that conveys destination information upwards along the DODAG so that a DODAG root (and other intermediate nodes) can provision downward routes. A DAO message includes prefix information to identify destinations, a capability to record routes in support of source routing, and information to determine the freshness of a particular advertisement. Notably, “upward” or “up” paths are routes that lead in the direction from leaf nodes towards DAG roots, e.g., following the orientation of the edges within the DAG. Conversely, “downward” or “down” paths are routes that lead in the direction from DAG roots towards leaf nodes, e.g., generally going against the orientation of the edges within the DAG.

Generally, a DAG discovery request (e.g., DIO) message is transmitted from the root device(s) of the DAG downward toward the leaves, informing each successive receiving device how to reach the root device (that is, from where the request is received is generally the direction of the root). Accordingly, a DAG is created in the upward direction toward the root device. The DAG discovery reply (e.g., DAO) may then be returned from the leaves to the root device(s), informing each successive receiving device in the other direction how to reach the leaves for downward routes. Nodes that are capable of maintaining routing state may aggregate routes from DAO messages that they receive before transmitting a DAO message. Nodes that are not capable of maintaining routing state, however, may attach a next-hop address to a reverse route record stack (e.g., a “Reverse Route Stack” contained within a RPL DAO message). The reverse route record stack may then be subsequently used to generate piecewise source routes (for packets 140-s) over regions of the DAG that are incapable of storing downward routing state.

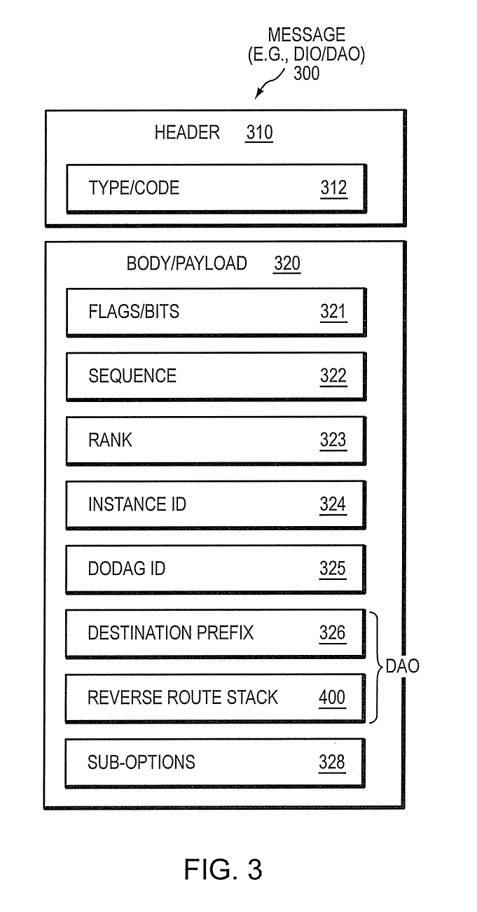

FIG. 3 illustrates an example simplified control message format 300 that may be used for discovery and route dissemination when building a DAG, e.g., as a DIO or DAO. Message 300 illustrative comprises a header 310 within one or more fields 312 that identify the type of message (e.g., a RPL control message), and a specific code indicating the specific type of message, e.g., a DIO or a DAO (or a DAG Information Solicitation). Within the body/payload 320 of the message may be a plurality of fields used to relay the pertinent information. In particular, the fields may comprise various flags/bits 321, a sequence number 322, a rank value 323, an instance ID 324, and a DAG ID 325, and other fields, each as may be appreciated in more detail by those skilled in the art. Further, for DAO messages, additional fields for destination prefixes 326 and a reverse route stack 400 may also be included. For either DIOs or DAOs, one or more additional sub-option fields 328 may be used to supply additional or custom information within the message 300. For instance, an objective code point (OCP) sub-option field may be used within a DIO to carry codes specifying a particular objective function (OF) to be used for building the associated DAG.

As noted above, typical DAG architectures, such as RPL and other distance vector routing protocols, have each node in a network manage information about its peers and their roles, e.g., based on DAG edges. However, since in such situations, no node has information on the complete network topology, a system administrator also has no way of is knowing what is the DAG structure, if it is changing, and whether the DAG has been built and maintained correctly.

Various approaches have been suggested to remedy this situation, such as additional applications to report to a central authority as the DAG edges are discovered, constructed, and maintained. However, such systems will consume valuable computing resources, and will most likely be customized applications with unfortunately little or no interoperability between devices. Other lightweight approaches have also been suggested, such as a reduced Simple Network Management Protocol (SNMP) system, but these approaches are still too expensive in terms of memory footprint and, even more so, in terms of utilized bandwidth.

DAG Topology Reporting

According to one or more embodiments of the disclosure, routing protocol messages, such as RPL DIOs and DAOs, may be leveraged to provide management information that could be used by the DAG root to determine a DAG network topology. In particular, as described herein, a root device may request, e.g., in a DIO, that each device within the DAG add its device identification (ID) to a reverse route record stack for each route of a DAG discovery reply (e.g., DAO) propagated up the DAG toward the root device. Upon receiving one or more DAG discovery replies, the root device may compile the recorded routes from the reverse route record stacks into a DAG network topology.

Illustratively, the techniques described herein may be performed by hardware, software, and/or firmware, such as in accordance with a topology management process 248 for root device functionality, which may contain computer executable instructions executed by the processor 220 to perform functions relating to the novel techniques described herein, e.g., in conjunction with routing process 244 and DAG process 246. Further, non-root nodes within the DAG may perform the techniques herein in accordance with DAG process, e.g., configured specifically to perform the functions herein (e.g., at least one node in the DAG) or in a default manner for less-capable devices, as described herein.

Operationally, a root device (e.g., LBR) may determine or otherwise detect a trigger to learn a network topology of the DAG for which it is responsible. For instance, the trigger may be expiration of a periodic timer (e.g., periodically learning the topology) or on demand to retrieve management information, such as based on receiving a request or instruction from a system administrator. In addition, in certain embodiments, the trigger may simply be the building or refreshing of a DAG, such that each time a DAG is built or refreshed (e.g., an increased sequence number), the root may learn the topology of the (re)built DAG.

In response to the trigger, the root device may illustratively transmit a DAG discovery request 300 down the DAG, such as a RPL DIO, along with a special route record request. In particular the route record request may be used to request that each receiving device within the DAG add its device identification (ID), such as a network address, to a reverse route record stack 400 for each route of a DAG discovery reply (e.g., a DAO) propagated up the DAG toward the root device. Illustratively, the request may take the form of a bit or flag 321 (e.g., a “record bit” or “R-bit”) within the DAG discovery request, though other fields and messages may be used to relay the request to the nodes of the DAG.

When a particular device/node of the DAG receives the request and detects the route record request (e.g., bit/flag 321), then that receiving device (e.g., device 12) may forward the request further down the DAG, and may wait for expiration of a timer configured to allow receipt of DAG discovery replies from downstream DAG devices (e.g., a DAO delay timer). Upon expiration of the delay timer, the particular device may build a DAG discovery reply (e.g., DAO) message, and adds their device ID (e.g., address) in the reverse route stack field 400, e.g., incrementing a route record count (rr-count) value if required by the underlying routing protocol, and transmits the DAG discovery reply up the DAG toward the root device.

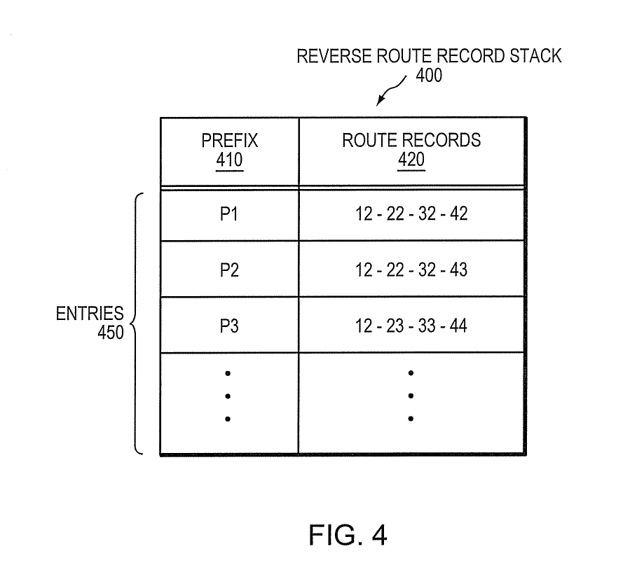

FIG. 4 illustrates an example reverse route record stack 400 that may be carried in a DAG discovery reply message 300. Illustratively, the stack 400 may comprise one or is more entries 450, each corresponding to a particular reachable prefix/route 410 having a list of route records (ordered device IDs) 420. For example, in correlation with FIG. 1, assume that prefix “P1” is reachable by device 42. Upon receiving the route record request, device 42 may add its ID to the reverse route record stack for an entry related to P1, and forwards the corresponding DAG discovery reply up the DAG to device 32. Additionally, device 43 may add its ID to the reverse route record stack for an entry related to P2, and may forward that DAG discovery reply to device 32, as well.

Device 32 may receive the reply messages (e.g., DAOs) from 42 and 43 after expiration of the associated timer, and may then add its ID to the reverse route record stack, e.g., pushing its ID onto the stack in front of other entries, such that the stack includes entries 450 for P1 and P2. Notably, device 32 is illustratively a less capable device that is not configured to store routing entries (e.g., a “non-storing node”). As with any devices that are unable to record routing state, device 32 may continue to add its address in the stack 400 for source routing to each route/prefix in the reply. In other words, the operation of capable devices (e.g., storing nodes who would normally store routing state) may be modified to add their device ID to the route record stack 400 without removing any stack currently in place as part of processing the route record request (e.g., the “R-bit”), while less capable devices may simply perform according to their standard instruction set.

Continuing toward the root, device 32 may forward the reply to device 22, which also adds its device ID to the stack 400 for each route to P1 and P2, and forwards the associated reply to device 12. Assume also that information regarding a prefix P3 also traversed the DAG in reverse from device 44, to device 33, to device 23, to device 12, a path of fully capable (route storing) devices. The stack 400 shown in FIG. 4 may thus illustrate an example stack for prefixes P1, P2, and P3 after device 12 has added its ID to the associated stacks. Conventionally, device 12 (e.g., and 23 and 33) may have compressed or otherwise consolidated the remaining route to the prefixes, since they are capable of storing the routing information should they receive a packet 140 so destined. However, according to the techniques herein, in order to establish the DAG topology in is response to the root's request, the capable nodes (and devices that are unable of storing routes) act differently by appending their IDs to the stack without further modification (i.e., without compressing or consolidating the remaining route to the prefixes). If there are a plurality of downstream paths from which a DAG device receives a stack 400, the stacks may be compiled into the separate entries, e.g., as shown at device 22 for P1 and P2, and then at device 12 for P1/P2 and P3.

When the root receives the DAG discovery replies (e.g., DAO messages) from its downstream neighbors, it may compile the recorded routes of the reverse route record stacks contained therein into a DAG network topology. In other words, the root device may look to the stack field to trace the path that the reply message had followed from each destination end point along the DAG. This information may be stored (e.g., topologies 249) and also reported as desired, such as displaying the topology locally or sending the information to an external agent for a visual display or processing.

By requesting the actions described above from all of the nodes in the DAG, the root node is in effect forcing all nodes of the DAG to send the desired information as though no nodes/devices in the network are capable of storing any routes. In other words, the request instructs the nodes to treat each and every route to any destination address prefix as a source routed route. In this manner, the root device may learn all prefixes and all routes to all prefixes through the DAG, creating a full network topology, which may be used for management purposes such as optimization, reporting, etc.

Additionally, in one or more embodiments, when a subsequent iteration of topology learning is completed, the root device can compare the newly received information with the stored information (a previous DAG network topology) and determine whether the DAG management information (topology) has changed. For example, monitoring for changes can be helpful when troubleshooting the network, such as when nodes (e.g., and sub-DAGs) fail to respond. The root device may thus compare the previous information to deduce which nodes have failed. Notably, the root device in one or more embodiments may be configured to only report changes to a system administrator, while otherwise merely maintaining a previous DAG topology iteration to is compare against a subsequent iteration.

Beyond root device intelligence, according to one or more embodiments herein, topology changes may be reported to the root device; that is, the trigger at a particular non-root device to return the requested information may be performance of a local repair. For instance, in response to a link or node failure, a global or local repair may be performed within a DAG. A global repair is triggered by the root device requesting that a DAG be rebuilt (e.g., a new sequence number within a DIO), and the request to learn the new topology may be included within the DAG discover message as described above. In addition, however, a local repair may be performed by a non-root device by recomputing a portion of a DAG that is affected by the failure. According to local policy, then, a device in the network that selects a new parent as a result of local repair may be configured to sends a new DAG discovery reply (e.g., DAO) with the appropriate reverse stack field 400 once updated. Note that the route record request of the DAG discovery request may include a specific indication that a reply is to be sent toward the root device by a particular device in the DAG in response to a local repair being performed by the particular device. Alternatively, the local repair notification may be a standard operation when receiving any route record request, that is, sending a reply to the root device in response to a local repair according to default behavior without having been specifically requested to do so by the root device. In addition, in one embodiment a DAG device may be configured to simply inform the DAG root that a local repair has occurred, without additional information, at which time the DAG root may respond by requesting a global rebuild and/or a re-learning of the DAG topology. Also, even in response to a local repair notification that includes the new route record stack for the new repaired topology, the DAG root may still request a global rebuild and/or a re-learning of the DAG topology, e.g., in order to ensure accuracy of the information.

Other DAG management information may also be included within the reply, such as traffic metrics/statistics, regarding the routes carried in the DAG discover replies. For instance, the information may be added to the sub-options field 328, or within additional fields of the reverse route record stack 400 (though this embodiment may require changes to standard protocols). Note that the information may be compressed to prevent packet fragmentation, if necessary. Example traffic metrics may comprise a number of packets handled by a particular device (total or per prefix), a number of packets redirected (total or per prefix) and to where, and a rate of packets handled (total or per prefix). In this manner, the root device may build a traffic matrix corresponding to the DAG network topology based on the traffic metrics. In this manner, more information is available for DAG management, such as whether certain prefixes are stored that are not used, etc.

The transmission of traffic metrics may occur in response to determining that a metric threshold has been reached at the particular device, such as a certain number of packets handled (e.g., nearing a maximum capacity), a number of packets redirected (e.g., any to learn of “short-cuts” below), etc. In one embodiment, local policy may define whether the status changes are to be reported immediately, or along with regular routing updates (e.g., periodic DAG discovery replies), such as where a next update/reply is due within a reasonable time window. Note further that the transmission of traffic metrics may be carried within a sub-options field 328 of a DAG discovery reply (e.g., DAO) message, or, alternatively, may be carried in a separate, e.g., newly defined, management message suitable for relaying the information.

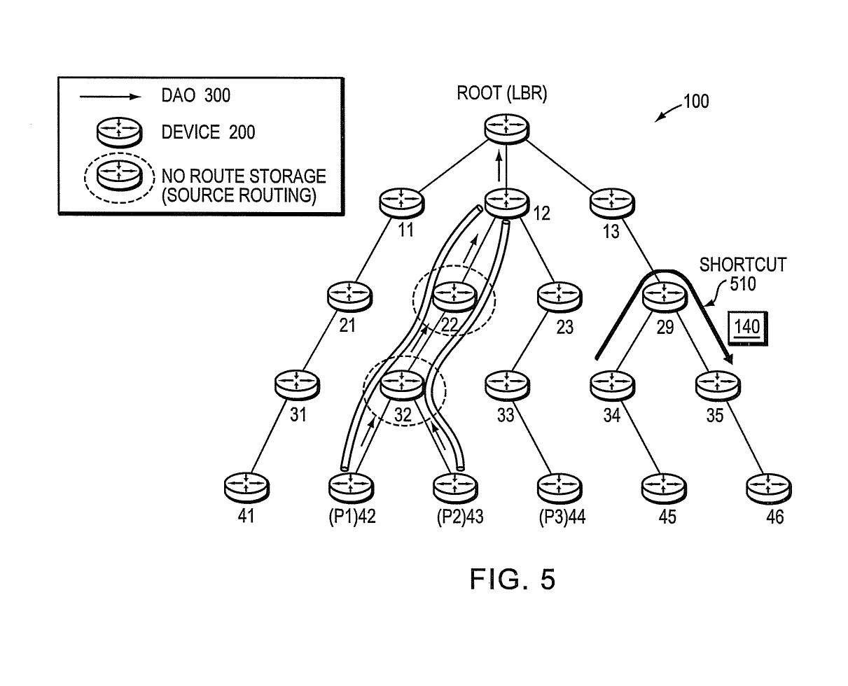

As mentioned above, the techniques herein may be used to learn of any “shortcuts” within the DAG, which are typically unseen to the DAG root device. For example, FIG. 5 illustrates the network/DAG of FIG. 1 with an additional indication of a short-cut 510 between device 34 and 35 through device 24. In particular, once a DAG structure has been computed, a path followed by a packet between two nodes (e.g., device 34 and 35) is such that the packet travels in upward toward the root to a common ancestor of the two devices (e.g., device 24), at which point the packet gets redirected downward toward the other device (e.g., device 35). Such “shortcuts” are generally more optimal paths that travelling all the way to the root, but they are not known to the root as the root correspondingly sees no traffic from it. To allow the root to learn of the shortcuts (e.g., point-to-point path optimality) for management purposes, the number of packets redirected by a particular device may be relayed to the root, as mentioned above (e.g., in response to exceeding some threshold).

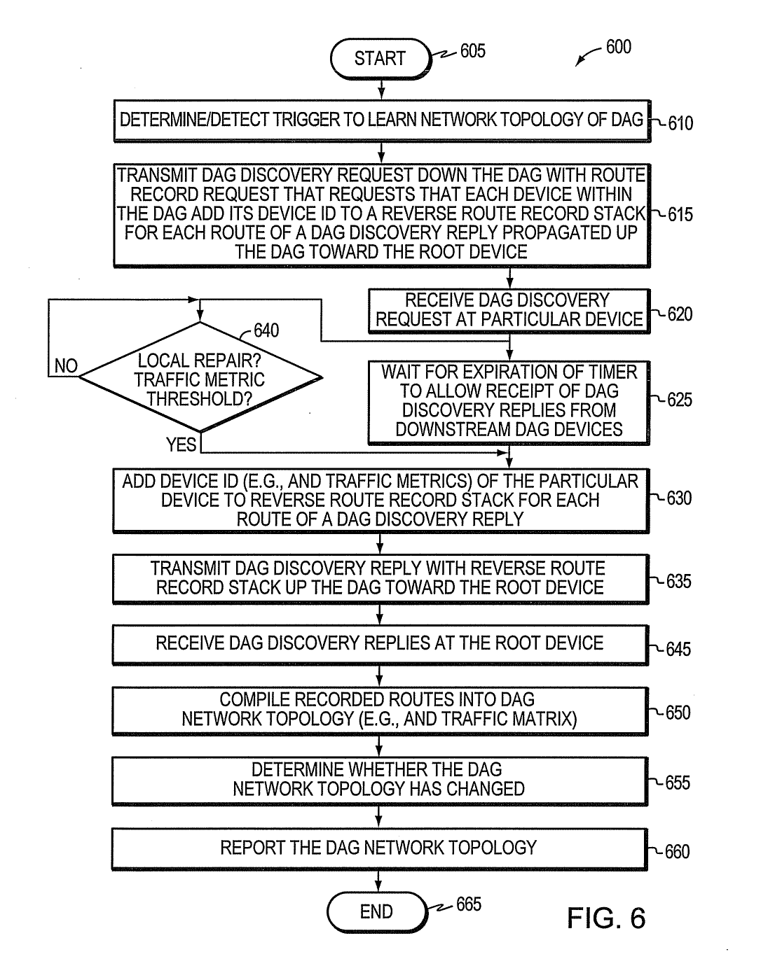

FIG. 6 illustrates an example simplified procedure for providing dynamic DAG is topology recording in accordance with one or more embodiments described herein. The procedure 600 starts at step 605, and continues to step 610, where a root device (e.g., LBR) determines or detects a trigger to learn the network topology of a DAG for which the root device is responsible. For instance, as noted above, various triggers include periodic timers, on demand (e.g., administrator request), or during an initial request to build the DAG in the first place. Accordingly, in step 615 a DAG discovery request 300 (e.g., DIO) may be transmitted down the DAG with a route record request (e.g., a bit/flag 321) that requests that each device within the DAG add its device ID (e.g., address) to a reverse route record stack 400 for each route of a DAG discovery reply 300 (e.g., DAO) propagated up the DAG toward the root device.

Each particular device 200 of the DAG may, in step 620, receive the DAG discovery request (e.g., DIO), and, optionally after waiting for expiration of timer to allow receipt of DAG discovery replies from downstream DAG devices in step 625, may add (e.g., push) its device ID to the reverse route record stack 400, accordingly. Notably, as mentioned above, the particular device may also (at this time or subsequently) add various traffic metrics to the response, such as in sub-options field 328. The DAG discovery reply 300 (and stack 400) may then be transmitted up the DAG toward the root device in step 635. Additionally, as described above, other triggers may occur at the particular device that call for information, such as performance of a local repair or surpassing a pre-defined traffic metric threshold in step 640. As such, in response to those optional triggers, the particular device may add its device ID and any corresponding traffic metrics to a reply message in step 625.

In step 645, the root device may receive the DAG discovery replies, and then in step 650 may compile the recorded routes into a DAG network topology. Also, where requested, the root device may further create a traffic matrix based on received metrics. In the event the created topology has at least one predecessor, then in step 655 the root device may compare the recent topology to an older topology (e.g., the preceding topology) to determine whether there are any changes to report. In step 660, the DAG network topology may be reported (or simply stored for future comparisons), and the procedure 600 ends in step 665.

The novel techniques described herein provide dynamic DAG topology recording and traffic matrix generation in a computer network. In particular, the techniques described above support on-demand or periodic updates of management information, as well as incremental updates to limit the traffic in the network. Further, by piggy-backing the information within the routing data of DAG reply messages (e.g., DAOs), the technique has minimal cost (overhead) to management of LLNs. Further, an efficient mechanism is described to report “shortcuts” by nodes of the DAG to the root, since the short-cuts are normally not visible to the root, such that a traffic matrix may be built for more optimal paths or other management purposes.

While there have been shown and described illustrative embodiments that provide dynamic DAG topology recording in a computer network, it is to be understood that various other adaptations and modifications may be made within the spirit and scope of the embodiments herein. For example, the embodiments have been shown and described herein with relation to LLNs, and more particular, to the RPL protocol. However, the embodiments in their broader sense are not so limited, and may, in fact, be used with other types of networks and/or protocols utilizing DAG routing (e.g., distance vector protocols).

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible computer-readable medium (e.g., disks/CDs/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
determining, by a root device of a directed acyclic graph (DAG) in a computer network, a trigger to learn a network topology of the DAG;
in response, transmitting a DAG discovery request down the DAG, the DAG discovery request having a route record request that requests that each device within the DAG add its device identification (ID) to a reverse route record stack for each route of a DAG discovery reply propagated up the DAG toward the root device;
receiving one or more DAG discovery replies at the root device; and
compiling recorded routes of the one or more reverse route record stacks of the one or more DAG discovery replies into a DAG network topology.

2. The method as in claim 1, further comprising:
reporting the DAG network topology.

3. The method as in claim 1, further comprising:
determining whether the DAG network topology has changed since a previous DAG network topology.

4. The method as in claim 1, further comprising:
determining the trigger on demand.

5. The method as in claim 1, further comprising:
determining the trigger based on a periodic timer.

6. The method as in claim 1, wherein devices within the DAG that are unable to record state are configured to also add their respective device ID to the reverse route record stack for each route of the DAG discovery reply.

7. The method as in claim 1, wherein the route record request includes an indication that a reply is to be sent toward the root device by a particular device in the DAG in response to a local repair being performed by the particular device.

8. The method as in claim 1, wherein the route record request includes a request to include within the DAG discovery replies a set of traffic metrics regarding the routes carried in the DAG discovery replies.

9. The method as in claim 8, wherein the traffic metrics are selected from a group consisting of: a number of packets handled, a number of packets redirected, and a rate of packets handled.

10. The method as in claim 8, further comprising:
building, at the root device, a traffic matrix corresponding to the DAG network topology based on the traffic metrics.

11. The method as in claim 1, further comprising:
utilizing DAG routing according to a Routing Protocol for Low Power and Lossy Networks (RPL).

12. An apparatus, comprising:
one or more network interfaces adapted to communicate on a directed acyclic graph (DAG) in a computer network;
a processor coupled to the network interfaces and adapted to execute one or more processes; and
a memory adapted to store a root device process executable by the processor, the process when executed operable to:
determine, as a root device of the DAG, a trigger to learn a network topology of the DAG;
transmit a DAG discovery request down the DAG in response to the trigger, the DAG discovery request having a route record request that requests that each device within the DAG add its device identification (ID) to a reverse route record stack for each route of a DAG discovery reply propagated up the DAG toward the apparatus;
receive one or more DAG discovery replies; and
compile recorded routes of the one or more reverse route record stacks of the one or more DAG discovery replies into a DAG network topology.

13. A method, comprising:
receiving, at a particular device of a directed acyclic graph (DAG) in a computer network, a DAG discovery request transmitted down the DAG from a root device of the DAG, the DAG discovery request having a route record request;
in response to the route record request, adding a device identification (ID) of the particular device to a reverse route record stack for each route of a DAG discovery reply; and
transmitting the DAG discovery reply up the DAG toward the root device.

14. The method as in claim 13, further comprising:
waiting for expiration of a timer configured to allow receipt of DAG discovery replies from downstream DAG devices prior to adding the device ID and transmitting the DAG discovery reply.

15. The method as in claim 13, wherein the device ID is a network address of the device.

16. The method as in claim 13, further comprising:
determining that a local repair has been performed by the particular device; and
in response, transmitting a reply message toward the root device from the particular device indicating the local repair.

17. The method as in claim 13, further comprising:
including within the DAG discovery reply a set of traffic metrics regarding the routes in the reply.

18. The method as in claim 17, wherein the traffic metrics are selected from a group consisting of: a number of packets handled, a number of packets redirected, and a rate of packets handled.

19. The method as in claim 17, further comprising:
determining that a metric threshold has been reached at the particular device; and
in response, transmitting a reply message toward the root device from the particular device indicating metric.

20. The method as in claim 13, further comprising:
utilizing DAG routing according to a Routing Protocol for Low Power and Lossy Networks (RPL).

21. An apparatus, comprising:
one or more network interfaces adapted to communicate on a directed acyclic graph (DAG) in a computer network;
a processor coupled to the network interfaces and adapted to execute one or more processes; and
a memory adapted to store a root device process executable by the processor, the process when executed operable to:
receive a DAG discovery request transmitted down the DAG from a root device of the DAG, the DAG discovery request having a route record request;
add, in response to the route record request, a device identification (ID) of the apparatus to a reverse route record stack for each route of a DAG discovery reply; and
transmit the DAG discovery reply up the DAG toward the root device.
